(19) United States
(12) Patent Application Publication
(10) Pub. No.: US 2022/0298436 A1
(43) Pub. Date: Sep. 22, 2022

(54) METHOD FOR MAKING AN IMPROVED LOHC FROM REFINERY STREAMS

(71) Applicant: The Claire Technologies Corporation, Danville, CA (US)

(72) Inventors: Paul A. Allinson, Danville, CA (US); Alan Klaassen, Kensington, CA (US); Curtis L. Munson, Oakland, CA (US); Steven F. Sciamanna, Orinda, CA (US); Charles R. Wilson, San Francisco, CA (US)

(73) Assignee: The Claire Technologies Corporation, Danville, CA (US)

(21) Appl. No.: 17/733,667

(22) Filed: Apr. 29, 2022

Related U.S. Application Data
(63) Continuation of application No. 17/684,118, filed on Mar. 1, 2022.
Application No. 17/684,118 is a continuation of application No. 17/497,903, filed on Oct. 9, 2021.
Application No. 17/497,903 is a continuation of application No. 17/488,867, filed on Sep. 29, 2021.
(60) Provisional application No. 63/181,969, filed on Apr. 30, 2021.
(60) Provisional application No. 63/155,741, filed on Mar. 3, 2021.
(60) Provisional application No. 63/091,425, filed on Oct. 14, 2020.
(60) Provisional application No. 63/088,024, filed on Oct. 6, 2020.

(30) Foreign Application Priority Data
Sep. 29, 2021 (US) PCT/US2021/052553
Oct. 9, 2021 (US) PCT/US2021/054323
Mar. 1, 2022 (US) PCT/US2022/018362

(51) Int. Cl. C10G 69/04

(52) U.S. Cl. CPC C10G 69/04; C10G 2300/1014; C10G 2300/1033

(57) ABSTRACT

Deep hydrotreating of fluid catalytic cracker cycle oil streams is used to produce lower cost Liquid Organic Hydrogen Carriers (LOHC) for use in large scale liquid batteries and other applications employing hydrogen or requiring a source of labile hydrogen. Coprocessing of bio-feedstocks in a fluid catalytic cracking process is used to further provide lower cost materials and methods involving enhanced carbon-neutral applications of LOHC systems in large scale liquid batteries as well as in mobile applications including trucking, shipping, trains, and aviation employing LOHC products.

### PRIORITY

This application claims the benefit of the priority of U.S. utility patent application Ser. No. 17/497,903, entitled “Carbon-Neutral Process for Generating Electricity”, filed on Oct. 9, 2021; the benefit of the priority of International utility patent application Serial No. PCT/US2021/0543233, entitled “Carbon-Neutral Process for Generating Electricity”, filed on Oct. 9, 2021; the benefit of the priority of U.S. provisional patent application Ser. No. 63/091,425, entitled “Carbon-Neutral Process for Generating Electricity”, filed on Oct. 14, 2020; the benefit of the priority of U.S. utility patent application Ser. No. 17/488,867, entitled “Carbon-Neutral Process for Generating Electricity”, filed on Sep. 29, 2021; the benefit of the priority of International utility patent application Serial No. PCT/US2021/052553, entitled “Carbon-Neutral Process for Generating Electricity”, filed on Sep. 29, 2021; the benefit of the priority of U.S. provisional patent application Ser. No. 63/088,024, entitled “Carbon-Neutral Process for Generating Electricity”, filed on Oct. 6, 2020; the benefit of the priority of Unites States provisional patent application Ser. No. 63/155,741, entitled “Carbon-Neutral Energy Facility (CNEF) Business Method”, filed on Mar. 3, 2021; the benefit of priority of U.S. patent application Ser. No. 17/684,118, entitled “Liquid Carbon-Neutral Energy Facility System”, filed on Mar. 1, 2022; the benefit of priority of International utility patent application Serial No. PCT/US2022/018362, entitled “Liquid Carbon-Neutral Energy Facility System”, filed Mar. 1, 2022; and the benefit of the priority of U.S. provisional patent application Ser. No. 63/181,969, entitled “Method For Making An Improved LOHC From Refinery Stream”, filed on Apr. 30, 2021; all of which are hereby incorporated in their entirety by reference herein.

### FIELD

This disclosure relates generally to the carbon-neutral production, transportation, and storage of hydrogen. One of the known options for transportation and storage of hydrogen is the use of a Liquid Organic Hydrogen Carrier (“LOHC”) which can then be stored in tanks, and transported in trucks, pipeline, or by rail. At the site of use, the hydrogen is released in a catalytic reaction and the hydrogen captured for use in a fuel cell, combustion apparatus, or other application. This disclosure further relates generally to materials, means and processes tailored to create a reduced cost LOHC by using an aromatics rich refinery stream and catalytically hydrogenating these materials to produce a stream rich in cyclic hydrocarbons usable as an LOHC. This form of LOHC will be lower in cost, and much more plentiful to supply the large demand for hydrogen.

### BACKGROUND

A great deal of effort has been expended in developing systems that convert chemical energy into electricity. Having the capability of loading a gaseous, liquid, or solid material in the system for hydrogen conversion into electricity greatly increases the flexibility for the developing electrified economy. Hydrogen has been acknowledged for many years as a potential source of electrical energy by electrochemical hydrogen conversion that generates electrical energy. Hydrogen may be stored as a compressed gas or as liquid hydrogen at cryogenic temperatures. However, increasing the operating flexibility of an electric powered vehicle by providing high pressure hydrogen for electrochemical conversion and generation of additional electrical energy requires the storage of high-pressure hydrogen, along with its not insignificant associated risks. Furthermore, the lack of a hydrogen delivery infrastructure in virtually all locations limits applicability of a high-pressure hydrogen solution.

Hydrogen may be stored as the captured or contained gas in various carrier media such as metal hydrides, high surface area carbon materials, and metal-organic framework materials, or as a compressed gas or liquified at cryogenic temperatures. Generally, the contained hydrogen in such carrier media can be released by raising the temperature and/or lowering the hydrogen pressure.

Hydrogen can also be stored by means of a reversible catalytic hydrogenation of unsaturated, usually aromatic, organic compounds. An organic hydrogen carrier, referred to herein as a “liquid organic hydrogen carrier” (LOHC), is generally liquid at ambient conditions, and contains a significant amount of chemically bound hydrogen that may be liberated by an elevated temperature catalytic process. The release of hydrogen by dehydrogenation is an endothermic process, i.e., one which requires an input of heat, at a temperature where the dehydrogenation of the carrier can proceed with adequate reaction rates. Several methods have been suggested for generating the heat required to maintain the dehydrogenation reaction step, including combustion of hydrogen that is generated in the process, or combustion of a supplied fuel to provide the necessary heat. Using generated hydrogen as combustion fuel has a significant impact on hydrogen availability for generating electricity. Burning a combustion fuel in the conventional method for heat generation creates greenhouse emissions, which serves to neutralize the benefit of using carbon-neutral (CN) hydrogen as a source of system energy.

Liquid organic hydrogen carriers have been studied at laboratory, pilot, and industrial scale. Various candidate LOHC materials have been evaluated, including cyclic hydrocarbons, carbazoles, pyridines, quinolines, and pyrroles. Of this list, the two most common systems studied, and in-use include methylcyclohexane (MCH) and dibenzyl toluene (DBT). Pure or single-component hydrogen carriers make it easier to study laboratory fundamentals of an LOHC cycle, and easier to design and operate plants. However, use of such pure components are relatively expensive compared to various refinery streams, and their use extracts an economic penalty to an operating plant.

Use of conventional LOHC feedstocks as hydrogen carriers has had limited success on account of the relatively low efficiency of energy conversion, the challenges of operating a dehydrogenation reaction zone within size constraints while maintaining acceptable catalyst activity, and the requirement for generating thermal energy without using a portion of the generated hydrogen for thermal energy production and while maintaining carbon-neutral operation with hydrocarbon combustion.

Fluid catalytic cracking (FCC) is a common refinery process well known in the art. It is widely used to convert high-boiling point, high-molecular weight hydrocarbon fractions of petroleum crude oils into more valuable gasoline, olefinic gases and other products. Cycle oils are a mix of aromatics, cycloparaffins, olefins, and paraffins, including normal paraffins and isoparaffins.

FCC processes have also been increasingly used as a method of converting bio-feedstocks into fuels. Bio-feedstocks are carbon-neutral and include biomass particles, pyrolysis oil, and other bio-derived oils. FCC is known in the art to remove as much as 99% of oxygen contained in bio-feedstocks and FCC processing of bio-mass particles has also been demonstrated, as disclosed in U.S. Pat. Nos. 8,829,258 and 9,028,676, both issued to Gong et al.

### SUMMARY

In one aspect, the present disclosure provides a process to produce a recyclable LOHC that is chemically stable and normally liquid at ambient conditions. In another aspect, the present disclosure provides a low-cost LOHC blend that balances the available supplies of carbon-neutral and conventionally sourced hydrogen-rich hydrocarbons for the generation of carbon-neutral electricity and associated carbon-neutral processes. In a related aspect, the present disclosure provides a process to produce recyclable LOHC products that are blends of cyclic hydrocarbons and cycloparaffin-rich materials derived from crude oil sources. In yet further aspects, the present disclosure provides a process to produce recyclable LOHC products that contain sources of hydrocarbons derived from carbon-neutral resources and processes including bio-derived, carbon-neutral materials.

In another aspect, the present disclosure provides the means to provide the thermal energy for dehydrogenation without consuming a portion of the generated hydrogen while still maintaining an overall carbon-neutral process. This is done by including bio-derived, carbon-neutral content in the LOHC produced in this process which, in-turn, allows for some of either the LOHC or dehydrogenated LOHC to be burned to provide the heat required for the dehydrogenation reaction.

In yet another aspect, the present disclosure provides the means to use FCC processes to manufacture stable, multicomponent and reduced cost LOHC, and yet alternatively an LOHC that contains a portion of carbon-neutral organic material.

In a further aspect, the present disclosure provides the means to combust a small portion of an LOHC while maintaining an overall carbon neutral process, as long as the carbon-neutral fraction of the LOHC is greater than the fraction of LOHC combusted.

### Terminology

As used herein, “wt %” refers to the percentage by weight (“weight %) of the referenced material or component in a composition or mixture of more than one material.

As used herein, “fuel oil” refers to high-boiling point, high-molecular weight hydrocarbon fractions of petroleum crude oils, and are also known as cycle oil, heavy oil, marine fuel, bunker, furnace oil, gasoil, and the like, and derivatives thereof including fractions obtained from the distillation of petroleum (crude oil). In general, these oils may include distillates (the lighter fractions) and residues (the heavier fractions).

As used herein, “feedstock” refers to highly aromatic cracked materials that are further upgraded by hydrogen processing to ultimately prepare an LOHC product according to the present disclosure.

As used herein, “hydrocarbons” refer to alkane compounds that are straight-chain, branched chain, cyclic and combinations thereof, and mixtures of compounds thereof.

As used herein, “cyclic hydrocarbon” refers to any hydrocarbon with a cyclic ring structure, including ring structures exhibiting aromatic properties and accordingly including both the saturated and unsaturated forms of the cyclic hydrocarbons, and further including those cyclic hydrocarbons with ring substituents.

As used herein, “paraffin” and “paraffinic hydrocarbons” refer to the waxy crystalline, semisolid or oily flammable substances obtained especially from distillates of wood, coal, petroleum, or shale oil that is a complex mixture of hydrocarbons (alkanes), generally containing between twenty and forty carbon atoms.

As used herein, “cycloparaffin” refers to a saturated cyclic hydrocarbon (alkane) of the formula CₙH₂ₙ.

As used herein, “isoparaffin” refers to hydrocarbons of the paraffin series which have a branched carbon chain.

As used herein, “paraffin” refers to hydrocarbons which have unbranched carbon chains, also referred to as normal alkanes (“n-alkanes”).

As used herein, the term “major portion” shall mean at least 50 wt % of the total portion, to about 80 wt % of the total portion of a material.

As used herein, the term “green hydrogen” is intended to refer to hydrogen, either as a gaseous molecule or as source of labile hydrogen, that is produced by using clean energy from surplus renewable energy sources, such as for example, but not limited to solar or wind power, to split water into two hydrogen atoms and one oxygen atom through a process called electrolysis, and gasification of biomass and subsequent steam reforming of the bio-syngas.

A used herein, the term “blue hydrogen” is intended to refer to hydrogen, either as a gaseous molecule or as a source of labile hydrogen that is produced from steam reforming and the byproduct carbon compounds are captured and stored underground through an industrial carbon capture and storage (CSS) process. “Blue hydrogen” is sometimes referred to as carbon-neutral (CN) as the emissions are not dispersed in the atmosphere.

### BRIEF DESCRIPTION OF THE DRAWINGS

FIG. 1 illustrates one embodiment of the present disclosure showing process steps, feedstock streams and apparatus for preparing a Liquid Organic Hydrogen (LOHC) product using conventional crude oil refinery processing equipment and means.

### DETAILED DESCRIPTION OF EMBODIMENTS

Described below are processes and systems that provide a novel liquid organic hydrogen carrier. Reference will be made in detail to various embodiments, examples of which are illustrated in the accompanying drawing. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatuses have not been described in detail so as not to unnecessarily obscure aspects of the embodiments.

### Feedstocks for Producing LOHC

In one embodiment, one or a mixture of refinery feedstocks are upgraded to an LOHC product using one or more hydrogenation and hydrocracking processing steps. The refinery feedstock that is useful in the production of the LOHC product may be selected from crude oil, straight-run crude oil, naphtha, FCC (fluid catalytic cracker) effluent, including an FCC light cycle oil, fractions of jet fuels, a coker product, coal liquefied oil, the product oil from the heavy oil thermal cracking process, the product oil from heavy oil hydrocracking, straight run cuts and distillates from a crude unit, and mixtures thereof. In one embodiment, a major portion of the feedstock has a boiling range of from about 250° F. to about 800° F. or alternatively from about 350° F. to about 600° F. Use of a refinery feedstock with appropriate properties will produce an LOHC at a fraction of the cost of MCH, DBT, or other hydrocarbon materials.

In one embodiment, the refinery feedstock is a cycle oil produced in an FCC unit. Fluid catalytic cracking is a common refinery process. It is widely used to convert high-boiling point, high-molecular weight hydrocarbon fractions of petroleum crude oils into more valuable gasoline, olefinic gases, and other products. Suitable cycle oils include mixtures of aromatics, cycloparaffins, olefins, and paraffins. Hydrogenated cycle oil can therefore become a hydrogen carrier.

The FCC unit may be co-fed with bio-derived feedstocks which include biomass particles, pyrolysis oil, and other bio-derived oils produced from a plant or animal biomass, including purposely grown energy crops, wood or forest residues, waste from food crops, horticultural waste, or food processing residues. Producing the bio-derived feedstocks may also involve one or more biomass conversion steps, such as pyrolysis, gasification, anaerobic digestion, or fermentation. In one embodiment, the FCC unit feedstock may be up to 100% bio-derived feedstocks.

The catalyst system employed in embodiments of the present disclosure may comprise at least two catalyst layers consisting of a hydrotreating catalyst and a hydrogenation or hydrocracking catalyst. Optionally, the catalyst system may also comprise at least one layer of a demetallization catalyst and at least one layer of a second hydrotreating catalyst. The hydrotreating catalysts may contain a hydrogenation component such as a metal from Group VIB and a metal from Group VIII, their oxides, their sulfides, and mixtures thereof, and may further contain an acidic component such as fluorine, small amounts of crystalline zeolite or amorphous silica alumina. The hydrocracking catalysts may in further embodiments contain a hydrogenation component such as a metal from Group VIB and a metal from Group VIII, their oxides, their sulfides, and mixtures thereof and may further contain an acidic component such as a crystalline zeolite or amorphous silica alumina.

One of the zeolites which is considered to be a good starting material for the manufacture of hydrocracking catalysts is the well-known synthetic zeolite Y as described in U.S. Pat. No. 3,130,007, which is hereby incorporated herein in its entirety by reference. A number of modifications to this material have been reported, one of which is ultra-stable Y-zeolite as described in U.S. Pat. No. 3,536,605, which is hereby incorporated herein in its entirety by reference. To further enhance the utility of synthetic Y-zeolite additional components can be added. For example, U.S. Pat. No. 3,835,027, which is hereby incorporated herein in its entirety by reference, describes hydrocracking catalysts containing at least one amorphous refractory oxide, a crystalline zeolitic aluminosilicate and a hydrogenation component selected from the Group VI and Group VIII metals and their sulfides and their oxides.

In further embodiments, a suitable hydrocracking catalyst is a co-mulled zeolitic catalyst comprising about 17 wt % alumina binder, about 12 wt % molybdenum, about 4 wt % nickel, about 30 wt % Y-zeolite, and about 30 wt % amorphous silica/alumina, which is generally described in U.S. patent application Ser. No. 870,011, filed by M. M. Habib et al., which is hereby incorporated herein in its entirety by reference. The referenced hydrocracking catalysts generally comprise a Y-zeolite having a unit cell size greater than about 24.55 Angstroms and a crystal size less than about 2.8 microns together with an amorphous cracking component, a binder, and at least one hydrogenation component selected from the group consisting of a Group VI metals, Group VIII metals, and mixtures thereof.

In preparing a suitable Y-zeolite for use in accordance with embodiments of the present disclosure, the process disclosed in U.S. Pat. No. 3,808,326, which is hereby incorporated herein in its entirety by reference, may be followed to produce a Y-zeolite having a crystal size less than about 2.8 microns. More specifically, the hydrocracking catalyst suitably comprises from about 30-90 wt % of Y-zeolite and amorphous cracking component, and from about 70-10 wt % of binder. In further embodiments, the catalyst comprises rather high amounts of Y-zeolite and an amorphous cracking component, for example, but not limited to from about 60-90 wt % of Y-zeolite and amorphous cracking component and from about 40-10 wt % of binder, and alternatively from about 80-85 wt % of Y-zeolite and amorphous cracking component, and from about 20-15 wt % of binder. In yet further embodiments, the catalyst includes use of silica-alumina as an amorphous cracking component.

In further embodiments, the amount of Y-zeolite in the catalyst ranges from about 5-70 wt % of the combined amount of zeolite and cracking component, or yet alternatively from about 10-60 wt % of the combined amount of zeolite and cracking component, or yet alternatively from about 15-40 wt % of the combined amount of zeolite and cracking component.

Depending on the desired unit cell size, the SiO₂:Al₂O₃ (silica-alumina)molar ratio of the Y-zeolite may have to be adjusted as desired for use in embodiments of the disclosed processes herein. There are many techniques described in the art which can be applied to adjust the unit cell size accordingly. It has been found that Y-zeolites having a silica-alumina molar ratio of from about 3 to about 30 can be suitably applied as the zeolite component of the catalyst compositions according to the present disclosure. Alternatively, Y-zeolites having a silica-alumina molar ratio from about 4 to about 12, and yet alternatively from about 5 to about 8 are also suitable for use herein.

The amount of cracking component such as silica-alumina in the hydrocracking catalyst may range from about 10-50 wt % in some embodiments, or alternatively from about 25-35 wt %, or yet alternatively from about 10-70 wt %. In further embodiments, the amount of silica in the silica-alumina ranges from about 20-60 wt % or alternatively from about 25-50 wt %. Further embodiments may employ so-called X-ray amorphous zeolites, i.e., zeolites having crystallite sizes too small to be detected by standard X-ray techniques, which can be suitably applied as cracking components according to embodiments of the present disclosure. The catalyst may also optionally contain fluorine at a level of from 0 to about 2 wt %.

In related embodiments, binders optionally present in the hydrocracking catalyst may suitably comprise inorganic oxides. Both amorphous and crystalline binders can be used, including but not limited to silica, alumina, clays and zirconia binders, and mixtures thereof.

In further embodiments, the amount of hydrogenation components in the catalyst may suitably range from about 0.5 to about 30 wt % of Group VIII metal component and from about 0.5 to about 30 wt % of Group VI metal component, calculated as metal per 100 parts by weight of total catalyst. In these particular embodiments, the hydrogenation components in the catalyst may be in an oxidic or sulphidic form, or combinations thereof. If a combination of at least one Group VI and one Group VIII metal component is present as mixed oxides, the hydrogenation catalyst may be subjected to a sulphiding treatment prior to use in hydrocracking processes according to the present disclosure. In yet further embodiments, suitable catalysts comprises one or more components of nickel or cobalt, and one or more components of molybdenum or tungsten or one or more components of platinum or palladium, and combinations thereof.

In suitable embodiments of the present disclosure, the hydrotreating catalyst may comprise from about 2-20 wt % of nickel and from about 5-20 wt % molybdenum. In further embodiments, the catalyst comprises 3-10 wt % nickel and from about 5-20 wt % molybdenum, or alternatively from about 5-10 wt % nickel and from about 10-15 wt % molybdenum, calculated as metals per 100 parts by weight of total catalyst. In yet further embodiments, the catalyst comprises from about 5-8 wt % nickel and from about 8 to about 15 wt % nickel, wherein the total weight percent of metals employed in the hydrotreating catalyst is at least 15 wt %. In one embodiment, the weight ratio of the nickel catalyst to the molybdenum catalyst is no greater than about 1:1.

In further embodiments, the active metals present in the hydrogenation and hydrocracking catalysts may comprise nickel and at least one or more VIB metal, or yet alternatively may further include nickel and tungsten, or nickel and molybdenum metal combinations. Typically, the active metals in the hydrogenation and hydrocracking catalysts may comprise from about 3-30 wt % nickel and from about 2-30 wt % tungsten, calculated as metals per 100 parts by weight of total catalyst, or alternatively from about 5-20 wt % nickel and from about 5-20 wt % tungsten, or yet alternatively from about 7-15 wt % nickel and from about 8-15 wt % tungsten, or in further alternative embodiments from about 9-15 wt % nickel and from about 8-13 wt % tungsten. In suitable embodiments for use in the disclosed processes herein, the total weight percent of the metals is from about 25 to about 40 wt %.

Optionally, the acidity of the hydrogenation and hydrocracking catalysts may be enhanced by adding at least between 1-2 wt % fluoride, or in alternative embodiments, may be replaced by a similarly high activity base metal catalyst where the support is an amorphous alumina or silica, or both, and wherein the acidity has been enhanced by a zeolite, such as an H—Y zeolite in a concentration of from about 0.5 to about 15 wt %.

In suitable embodiments, the effective diameter of the hydrotreating catalyst particles is about 0.1 inch, and the effective diameter of the hydrocracking catalyst particles is also about 0.1 inch, and the two catalysts may be intermixed in a weight ratio of about 1.5:1 (hydrotreating to hydrocracking catalyst).

Optionally in further embodiments, a demetallization catalyst may be employed in the catalyst system, typically including Group VIB and Group VIII metals deposited onto a large pore alumina support. Suitable metals then include nickel, molybdenum and the like. In additional embodiments, at least about 2 wt % nickel is employed and at least about 6 wt % molybdenum, and yet alternatively the demetallization catalyst may be promoted for enhanced performance with the presence of at least about 1 wt % phosphorous. Optionally, a second hydrotreating catalyst may also be employed in the catalyst systems of the present disclosure, including alternative embodiments wherein the second hydrotreating catalyst comprises the same hydrotreating catalyst as described herein.

A further general embodiment according to the present disclosure includes a method of producing a liquid organic hydrogen carrier (LOHC) product from a refinery feedstock comprising the steps of first combining a refinery feedstock with a bio-derived feedstock to produce a feedstock blend which is then subject to a fluid catalytic cracking operation conducted in a fluid catalytic cracking to produce a cracked fraction as an intermediate process stream. In further embodiments, this intermediate cracked fraction process stream is then combined with a dehydrogenated LOHC feed to obtain a combined cracked fraction that is then subject to a hydroprocessing operation conducted in a hydroprocessing upgrading unit which produces a cycloparaffin-enriched intermediate product. In further embodiments the resulting cycloparaffin-enriched intermediate product is then subject to a distillation operation conducted in a conditioning and fractionization unit to obtain a LOHC product.

In further embodiments, a refinery feedstock and a bio-derived feedstock may be separately subjected to a first and second fluid catalytic cracking operation in one or more FCC units to produce a first and second intermediate cracked fraction, respectively; and then the first and second intermediate cracked fractions may be combined to produce a cracked fraction intermediate for further processing.

In a related embodiment, a dehydrogenated LOHC feed 104 and a cracked fraction may be separately subjected to a hydroprocessing operation conducted in one or more hydroprocessing upgrading units to produce a first and second cycloparaffin-enriched intermediate product, respectively; and then the first and second cycloparaffin-enriched intermediate products may be combined to produce a cycloparaffin-enriched intermediate product.

Further embodiments contemplate use of a refinery feedstock as an initial input stream selected from a straight-run petroleum distillate, straight-run crude oil distillate, fluid catalytic cracker (FCC) effluent, FCC light cycle oil, jet fuel fraction, coker product, coal liquefied oil, product oil from a heavy oil thermal cracking process, product oil from heavy oil hydrocracking, straight run cuts from a crude unit, heavy gas oil (HGO), heavy vacuum gas oil (HVGO), and mixtures thereof. In related embodiments, the refinery feedstock is a crude petroleum distillate with a normal boiling range of between 100 to 900° F. In further related embodiments an intermediate feedstock blend comprises between 0.5 to 20 wt % of the bio-derived feedstock, the latter of which may be selected from biomass particles, pyrolysis oil, bio-derived oils produced from a plant or animal biomass, plant biomass from purposely grown energy crops, wood, forest residues, waste from food crops, horticultural waste, waste from food processing residues, and combinations thereof.

In some embodiments, an LOHC product according to the present disclosure is selected to have between 0.5 to 20 wt % of a hydrocarbon derived from a carbon-neutral source or produced by a carbon-neutral process, or in the alternative is selected to be a multicomponent mixture of cycloparaffins having a cycloparaffin content of at least 72 wt % and an isoparaffin content of less than or equal to 28 wt %, or in yet another alternative is selected to contain between 0.5-20 wt %, or alternatively between 0.5-10 wt %, or alternatively between 0.5-5 wt % of total carbon-neutral component, or in a further alternative is selected to have between 1 to 10 wt % of labile hydrogen.

In additional embodiments, an LOHC product according to the present disclosure is selected wherein its labile hydrogen content is derived from green or blue hydrogen sourced from a carbon-neutral material, a carbon-neutral process, and combinations thereof.

In one embodiment, an LOHC product according to the present disclosure may be subjected to a second distillation operation to recover a distillate fraction of the LOHC product with a boiling range of between 250 to 800° F.

In further embodiments, the hydroprocessing operations conducted in the hydroprocessing upgrading unit as disclosed herein uses hydrogen selected from a green or blue hydrogen source or carbon-neutral hydrogen generation process to produce a more environmentally acceptable LOHC product.

To measure and confirm the amount of carbon-neutral carbon content present in an LOHC product obtained according to the disclosed processes herein, the bio-derived content of the LOHC product may be verified by using an acceptable carbon-14 isotopic analysis, including but not limited to methods using accelerator mass spectrometry (AMS), ASTM D6866-21 Method B as disclosed and incorporated herein, isotope ratio mass spectrometry (IRMS), and combinations thereof.

In further embodiments to tailor the LOHC product to a specific use according to the present disclosure and incorporated references, it may be further distilled and a distillate fraction isolated therefrom to obtain a tailored LOHC product having a boiling range of between 80 to 120° C., or alternatively between 120 to 370° C., or yet alternatively between 370 to 420° C.

### Specific Embodiments

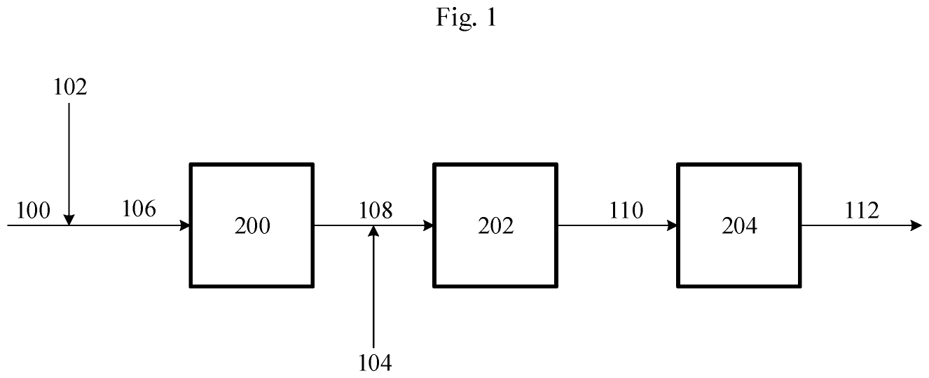

FIG. 1 illustrates embodiments of the present disclosure relating to processes and means to produce the LOHC materials described herein in block diagram form. In one embodiment, a fluid catalytic cracking (FCC) unit 200 fed with a refinery feedstock 100 is employed using catalysts as described herein to produce a cracked fraction 108 as a product of a first fluid catalytic cracking process step. In a related embodiment, the refinery feedstock 100 is combined with a bio-derived feedstock 102, which may include biomass particles, pyrolysis oil and other bio-derived oils, to produce a combined feedstock blend 106 that is co-processed to achieve a cracking upgrade and alternative cracked fraction 108 that is bio-enhanced as a product of a second alternative fluid catalytic cracking process step. In yet another related embodiment, the two input fractions to 200 may be processed separately by FCC unit 200 and combined after a first and second fluid catalytic processing operation to produce an essentially equivalent cracked fraction 108 suitable for additional processing as disclosed herein.

In further embodiments, the refinery feedstock 100 may be selected from the sources disclosed herein above obtained from refinery feedstocks, including but not limited to straight-run petroleum distillate, straight-run crude oil distillate, FCC (fluid catalytic cracker) effluent, including an FCC light cycle oil, fractions of jet fuels, a coker product, coal liquefied oil, the product oil from the heavy oil thermal cracking process, the product oil from heavy oil hydrocracking, straight run cut from a crude unit, and mixtures thereof.

In alternative embodiments, the refinery feedstock 100 may be selected from heavy gas oil (HGO), which is that portion of the petroleum (crude oil) that has an initial boiling-point temperature of 340° C. (644° F.) or higher, at atmospheric pressure, and that has an average molecular weight that ranges from about 200 to 600 Daltons or higher. Suitable heavy gas oil is also known as “heavy vacuum gas oil” (HVGO). In a fluid catalytic cracking process conducted in FCC unit 200 using HGO, the HGO feedstock is heated to a high temperature and to a moderate pressure, and then is placed in contact with a hot, powdered catalyst, which breaks the long-chain molecules of the high boiling point hydrocarbon liquids into short-chain molecules, which then are collected as a vapor for further processing steps, or collected as a liquid for later use or in a continuing process step.

In further alternative embodiments, there are several processes in conventional refining that produce highly aromatic streams suitable for use as feed 100, including but not limited to fluid catalytic cracking, thermal coking and cracking, heavy oil hydrocracking, and combinations thereof. The lighter cycle oils recovered from the FCC unit 200 are a useful feedstock for further processing, particularly in further embodiments in which these materials are combined with bio-derived feedstock, including bio-derived feedstock 102, which are either carbon-neutral (CN) or have high CN content, including for example, but not limited to biomass sources such as biomass particles, pyrolysis oil from thermal pyrolysis or bio-oils, and other bio-derived oils.

In another embodiment, the bio-derived feedstock 102 may be processed separately by an FCC unit 200 either simultaneously with processing of feed 100 in a second FCC unit, or combined with the cracked fraction 108 from a separate fluid catalytic cracking process in second FCC unit 200, or processed in the same FCC unit and later combined with a cracked fraction 108 output from processing feed 100 separately. In embodiments in which the bio-derived feedstock 102 is separately processed, it is desirable to recover the 100°-400° C. boiling range fraction and then blend with an FCC treated cycle oil (feed 100) or alternatively blend with the cracked fraction 108 produced by a separately FCC processed crude-oil feed 100.

In embodiments using a bio-derived feedstock, suitable bio-derived input materials contain at least 0.1 wt % of a bio-oil, or alternatively at least 0.5 wt % of a bio-oil or yet alternatively at least 1 wt % or greater of a bio-oil.

In related embodiments, the bio-derived feedstock may contain at least 90 wt % CN content, or alternatively at least 75 wt % CN content, or alternatively at least 50 wt % CN content, or alternatively at least 25 wt % CN content, or alternatively at least 5 wt % CN content, or yet alternatively at least 0.5 wt % CN content.

One embodiment includes any feedstock that is highly aromatic and has up to about 80 wt % aromatics, optionally including up to 3 wt % sulfur and optionally including up to 1 wt % nitrogen. Suitable feedstocks have an aromatic carbon content of at least 40 wt %. Typically, such feedstocks have a boiling range from about 250° F. (121° C.) to about 800° F. (427° C.) or alternatively from about 350° F. (177° C.) to about 600° F. (316° C.).

In further embodiments, the cracked fraction 108 is then passed to a hydroprocessing upgrading unit 202 for hydrotreating or hydrocracking, or a combination of both as described herein above. In one embodiment, cracked fraction 108 may be selected from FCC effluent, including an FCC light cycle oil, fractions of jet fuels, a coker product, coal liquefied oil, product oil from the heavy oil thermal cracking process, product oil from heavy oil hydrocracking, straight run cuts obtained from a crude unit, and suitable combinations and mixtures thereof. In some related embodiments, the cracked fraction 108 and other optionally combined fractions and products are selected so that a major portion of the feedstock to be processed by 202 have a boiling range of from about 250° F. to about 800° F., or alternatively from about 350° F. to about 600° F. The cracked fraction 108 thus obtained from a hydroprocessing operation performed in the hydroprocessing upgrading unit 202 is then used as a feed in a subsequent process to convert the material further.

In yet alternative embodiments, a hydroprocessing operation performed in the hydroprocessing upgrading unit 202 may also be co-fed with the dehydrogenated LOHC feed 104, referred to as “spent” LOHC that is returned from its use in a hydrogen generation process that derives available hydrogen from a regenerated or hydrogenated LOHC source. Yet alternatively, the dehydrogenated LOHC feed 104 may be separately processed in a hydrogenation or hydrocracking or combined process step in unit 202, and then combined with the output from a prior or simultaneous second hydroprocessing operation performed in a first unit 202 or a second unit 202.

In other embodiments, hydroprocessing operation conducted in the hydroprocessing upgrading unit 202 may use hydrogen derived from a green or blue hydrogen source or carbon-neutral hydrogen generation process, such as for example, but not limited to, hydrogen generated from an electrochemical process conducted under carbon-neutral conditions, and other sources cited in the referenced applications, patents and literature incorporated herein.

In further embodiments, the spent LOHC source is fully carbon-neutral with respect to the material component source or alternatively with respect to the source of labile hydrogen present within the LOHC or yet alternatively with respect to the source of electricity or thermal energy used to produce the LOHC or convert spent LOHC into regenerated LOHC for use in a liquid battery or other carbon-neutral hydrogen generation process contemplated within the scope of the present disclosure. In further related embodiments, the relative amount of carbon-neutral component in the LOHC may be enhanced by utilizing waste heat obtained during a carbon-neutral conversion process, or alternatively by further utilizing electricity obtained from a carbon-neutral source or process, or yet alternatively using hydrogen derived from a carbon-neutral source or process, and yet even further a combination of these disclosed carbon-neutral sources of material, heat and energy.

In some embodiments, the Cycloparaffin-enriched intermediate product 110 from a hydrogenation step may be characterized by a cycloparaffin content of at least 72 wt % and containing little or no sulfur, having a hydrogen carrying capacity of between 6-7 wt %. In further embodiments, the cycloparaffin-enriched product 110 may be characterized by a cycloparaffin content of at least 72 wt % with a hydrogen carrying capacity of at least 4-5 wt %, being the labile hydrogen content of the resulting materials.

In further embodiments, the hydroprocessing operation may produce a hydrocarbon stream containing at least 72% cycloparaffins and little or no sulfur, using larger hydrocarbon feeds having hydrocarbon molecules in the 80-360° C. boiling range, and containing greater than 50 wt %, or alternatively greater than 60 w %, or alternatively greater than 65% cycloparaffin content.

In related embodiments, the input stream to the hydroprocessing upgrading unit 202 may be first pre-treated or processed to remove oxygen and sulfur, or alternatively pre-treated or processed to increase the saturated hydrogen content to above 1 wt %, or alternatively above 2 wt %, or alternatively above 3 wt %, or yet alternatively at least 4 wt % of labile hydrogen.

In other embodiments, a prior catalytically hydrogenated or hydrotreated hydrocarbon distillate fraction may be used as the input stream, wherein the selected fraction has a boiling range of from about 250° F. to about 800° F., or alternatively from about 350° F. to about 600° F., in order to remove heteroatoms (e.g. hydrocarbons containing sulfur, nitrogen and oxygen) and as well to partially convert aromatic hydrocarbon content to higher cycloparaffin content.

In related embodiments, the disclosed hydrogenation/hydrotreating catalytic processes and hydrocracking catalytic processes may occur in a single reaction step using a single catalyst, in two or more reaction steps occurring in separate layers or zones of catalyst in a single reactor vessel, or in separate reactor vessels for hydrotreating and for hydrocracking of the disclosed material feeds and materials.

In further embodiments, the cycloparaffin-enriched intermediate product 110 obtained after a hydroprocessing operation performed in the hydroprocessing upgrading unit 202 may then be subject to a distillation operation conducted in the conditioning and fractionization unit 204, which serves to isolate the various distillates thus obtained into different product fractions having desired boiling point ranges. For a LOHC product 112, fractions thus obtained include materials, depending on the ultimate use and application of the LOHC product, having boiling ranges between 80-420° C., or alternatively between 80-370° C., or alternatively between 80-120° C., or alternatively between 120-420° C., or alternatively between 370-420° C. In general, without being bound by theory, LOHC materials with higher cyclic hydrocarbon content have lower boiling points and exhibit lower boiling ranges compared to materials and products having lower cyclic hydrocarbon or lower cycloparaffin content, as cyclic hydrocarbons of identical molecular weight exhibit lower boiling points than their straight-chain or branched-chain isomers.

Ultimately, in further embodiments, the selected LOHC products boiling ranges obtained from the conditioning and fractionization unit 204 coincide with the desired boiling points and boiling ranges necessitated for optimum performance in a selected process employing the LOHC product, as disclosed by reference in the cited patent applications and patents and literature references incorporated herein. The LOHC product 112 thus obtained from the final distillation operation conducted in the conditioning and fractionization unit 204 can differ substantially with respect to the degree of cycloparaffin enrichment and corresponding boiling point and boiling point ranges depending on the intended application employing an LOHC product according to the disclosed embodiments.

In some applications, LOHC product is desired that exhibit boiling point ranges of between 100-400° C., or alternatively 200-350° C., and which contain at least 72 wt % cycloparaffins and have a carrying capacity or labile hydrogen content of at least) 1-10 wt %, or alternatively, 2-5 wt %, or alternatively 3-5 wt % or yet alternatively 4-5 wt % hydrogen. Suitable LOHC products may contain at least 0.5 wt % bioderived oil with the same physical properties of the embodiments disclosed herein immediately above.

Further, in additional related embodiments, the amount of carbon-neutral content of the resulting LOHC product 112 thus obtained from the final distillation operation conducted in the conditioning and fractionization unit 204 may be enhanced by the use of carbon-neutral materials, carbon-neutral components, and combinations thereof, and alternatively enhanced by utilizing waste heat obtained during a carbon-neutral conversion process, or alternatively by further utilizing electricity obtained from a carbon-neutral source or process, or yet alternatively using hydrogen derived from a carbon-neutral source or process, and yet even further a combination of these disclosed carbon-neutral sources of material, heat and energy. In yet further embodiments, the carbon-neutral equivalent content or environmental contribution, reduced greenhouse gas emissions, reduced carbon emissions and combinations thereof resulting from one or more of the disclosed process steps may be further enhanced by the capturing of any carbon or hydrocarbon emissions from the processes conducted in the disclosed processing units described herein.

In other embodiments, the LOHC product 112 may have an enhanced carbon-neutral content, and includes LOHC products obtained by any one or more processes as disclosed herein and which contain between 0.5-20 wt %, or alternatively between 0.5-10 wt %, or alternatively 0.5-5 wt % of total carbon-neutral component.

Determining the quantity of CN component in the LOHC product obtained from the processes disclosed herein may be done using ASTM D6866-21 Method B, entitled “Standard Test Methods for Determining the Biobased Content of Solid, Liquid, and Gaseous Samples Using Radiocarbon Analysis”, which is hereby incorporated in its entirety by reference. Also suitable for use herein are methods that enable the determination of naturally derived carbon content based on radioactive carbon-14 measurement, and other methods, such as isotope ratio mass spectrometry (IRMS) that measure ratios of carbon-12 to carbon-14 isotopes, and accelerator mass spectrometry (AMS) which measures the amount of a particular atomic ion or molecular ion, and from which an isotopic ratio may be readily determined to high accuracy.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method of producing a liquid organic hydrogen carrier (LOHC) product 112 from a refinery feedstock comprising the steps of:
a) combining a refinery feedstock 100 with a bio-derived feedstock 102 to produce a feedstock blend 106;
b) subjecting said feedstock blend 106 to a fluid catalytic cracking operation conducted in a fluid catalytic cracking (FCC) unit 200 to produce a cracked fraction 108;
c) combining said cracked fraction 108 with a dehydrogenated LOHC feed 104;
d) subjecting said combined cracked fraction 108 and dehydrogenated LOHC feed 104 to a hydroprocessing operation conducted in a hydroprocessing upgrading unit 202 to produce a cycloparaffin-enriched intermediate product 110; and
e) subjecting said cycloparaffin-enriched intermediate product 110 to a distillation operation conducted in a conditioning and fractionization unit 204 to obtain said LOHC product.

2. The method of claim 1, wherein said refinery feedstock 100 and said bio-derived feedstock 102 are separately subjected to a first and second fluid catalytic cracking operation in one or more FCC units 200 to produce a first and second intermediate cracked fraction, respectively; and wherein said first and second intermediate cracked fractions are combined to produce said cracked fraction 108.

3. The method of claim 1, wherein said dehydrogenated LOHC feed 104 and said cracked fraction 108 are separately subjected to a hydroprocessing operation conducted in one or more hydroprocessing upgrading units 202 to produce a first and second cycloparaffin-enriched intermediate product, respectively; and wherein said first and second cycloparaffin-enriched intermediate products are combined to produce said cycloparaffin-enriched intermediate product 110.

4. The method of claim 1, wherein said refinery feedstock 100 is selected from a straight-run petroleum distillate, straight-run crude oil distillate, fluid catalytic cracker (FCC) effluent, FCC light cycle oil, jet fuel fraction, coker product, coal liquefied oil, product oil from a heavy oil thermal cracking process, product oil from heavy oil hydrocracking, straight run cuts from a crude unit, heavy gas oil (HGO), heavy vacuum gas oil (HVGO), and mixtures thereof.

5. The method of claim 4, wherein said refinery feedstock 100 is a crude petroleum distillate with normal boiling range of between 100 to 900° F.

6. The method of claim 1, wherein said feedstock blend 106 comprises between 0.5 to 20 wt % of said bio-derived feedstock 102.

7. The method of claim 6, wherein said bio-derived feedstock 102 is selected from biomass particles, pyrolysis oil, bio-derived oils produced from a plant or animal biomass, plant biomass from purposely grown energy crops, wood, forest residues, waste from food crops, horticultural waste, waste from food processing residues, and combinations thereof.

8. The method of claim 1, wherein said LOHC product 112 comprises between 0.5 to 20 wt % of a hydrocarbon derived from a carbon-neutral source or produced by a carbon-neutral process.

9. The method of claim 1, wherein said LOHC product 112 comprises a multicomponent mixture of cycloparaffins having a cycloparaffin content of at least 72 wt % and an isoparaffin content of less than or equal to 28 wt %.

10. The method of claim 1, wherein said LOHC product 112 comprises between 0.5-20 wt %, or alternatively between 0.5-10 wt %, or alternatively between 0.5-5 wt % of total carbon-neutral component.

11. The method of claim 1, wherein said LOHC product 112 comprises between 1 to 10 wt % of labile hydrogen.

12. The method of claim 11, wherein said labile hydrogen comprises green or blue hydrogen sourced from a carbon-neutral material, a carbon-neutral process, and combinations thereof.

13. The method of claim 1, wherein said LOHC product 112 is subjected to a second distillation operation to recover a distillate fraction of said LOHC product with a boiling range of between 250 to 800° F.

14. The method of claim 1, wherein said hydroprocessing operation conducted in said hydroprocessing upgrading unit 202 uses hydrogen selected from a green or blue hydrogen source or carbon-neutral hydrogen generation process.

15. The method of claim 1 in which the bio-derived content of said LOHC product 112 is verified by using carbon-14 isotopic analysis; wherein said isotopic process is conducted by means of accelerator mass spectrometry (AMS), ASTM D6866-21 Method B as disclosed and incorporated herein, isotope ratio mass spectrometry (IRMS), and combinations thereof.

16. The method of claim 1 in which said LOHC product 112 is further distilled and a distillate fraction is isolated therefrom to obtain a second tailored LOHC product having a boiling range of between 80 to 120° C.

17. The method of claim 1 in which said LOHC product 112 is further distilled and a distillate fraction is isolated therefrom to obtain a third tailored LOHC product having a boiling range of between 120 to 370° C.

18. The method of claim 1 in which said LOHC product 112 is further distilled and a distillate fraction is isolated therefrom to obtain a fourth tailored LOHC product having a boiling range of between 370 to 420° C.
